(19) United States
(12) Patent Application Publication
(10) Pub. No.: US 2026/0267869 A1
(43) Pub. Date: Sep. 10, 2026

(54) PRESENTING QUERY RESULT

(71) Applicant: Beijing Zitiao Network Technology Co., Ltd., Haidian District, Beijing (CN)

(72) Inventors: Xiang Jiang, Beijing (CN); Han Li, Beijing (CN)

(21) Appl. No.: 19/101,485

(22) PCT Filed: Jun. 17, 2024
(86) PCT No.: PCT/CN2024/099672

§ 371 Date: Feb. 5, 2025

(51) Int. Cl. G06F 16/248

(52) U.S. Cl. CPC G06F 16/248

(57) ABSTRACT

Methods, apparatuses, devices, and media for presenting query results are provided. In one method, a query intention of a user is determined in response to receiving a query request from a user. A data structure for presenting a query result for the query request is determined based on the query intention. A set of data items from the query result is obtained based on the query request and the data structure. A set of data items is presented based on the data structure. According to the exemplary implementation manner of the disclosure, the presentation manner of the query result may be customized according to the user intention, and the query result is displayed in the rich media structured data, so that the query result is presented in a manner more easily understood by the user.

### FIELD

Example implementations of the present disclosure generally relate to the field of computers, and in particular, to methods, apparatuses, devices, and computer-readable storage media for presenting a query result for a query request.

### BACKGROUND

With the rapid development of computer technologies, applications may provide various services to users. For example, an application may provide a query service to a user. The application may obtain a query request (for example, a query text input by the user, that is, a “question”) from the user, and provide a query result corresponding to the question based on the query request. However, the query result provided by the existing application may not meet the requirement of the user, and the user may need to perform multiple queries, or need to neaten the query result manually, so as to obtain the expected answer. At this point, it may be desirable to determine and present the query results in a more efficient manner.

### SUMMARY

In a first aspect of the present disclosure, a method for presenting a query result is provided. In the method, a query intention of a user is determined in response to receiving a query request from a user. A data structure for presenting a query result for the query request is determined based on the query intention. A set of data items in the query result is obtained based on the query request and the data structure. A set of data items is presented based on the data structure.

In a second aspect of the present disclosure, an apparatus for presenting a query result is provided. The apparatus comprises an intention determining module configured to determine a query intention of a user in response to receiving a query request from a user; a structure determination module configured to determine a data structure for presenting a query result for the query request based on the query intention; an obtaining module configured to obtain a set of data items from the query result based on the query request and the data structure; and a presentation module configured to present a set of data items based on the data structure.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method of the first aspect of the present disclosure.

In a fourth aspect of the present disclosure, there is provided a computer-readable storage medium having stored thereon a computer program which, when executed by a processor, causes the processor to implement the method of the first aspect of the present disclosure.

In a fifth aspect of the present disclosure, there is provided a computer program product, comprising a computer program, wherein the computer program, when executed by a processor, implements the method of the first aspect of the present disclosure.

It should be understood that what is described in this content section is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 shows a block diagram of an application environment according to an exemplary implementation of the present disclosure;

FIG. 2 shows a block diagram for presenting query results according to some implementations of the present disclosure;

FIG. 3 shows a block diagram of a data structure for presenting query results according to some implementations of the present disclosure;

FIG. 4 shows a block diagram of a presentation page of a query result according to some implementations of the present disclosure;

FIG. 5 shows a block diagram of a presentation page of a query result according to some implementations of the present disclosure;

FIG. 6 shows a block diagram of a presentation page of a query result according to some implementations of the present disclosure;

FIG. 7 shows a flowchart of a method for presenting a query result according to some implementations of the present disclosure;

FIG. 8 shows a block diagram of an apparatus for presenting a query result according to some implementations of the present disclosure; and

FIG. 9 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include” and similar terms should be understood as open-encompassing, i.e., “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It can be understood that the data involved in the technical solution (including but not limited to the data itself, the acquisition or use of the data) should follow the requirements of the corresponding laws and regulations and related regulations.

It can be understood that, before the technical solutions disclosed in the embodiments of the present disclosure are used, the types, usage scope, usage scenarios, etc. of the personal information involved in the present disclosure should be notified to the user in an appropriate manner according to the relevant laws and regulations, and the authorization of the user is obtained.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It can be understood that the above-described process of notifying and obtaining a user authorization is merely schematic, and does not constitute a limitation on implementations of the present disclosure, and other manners of meeting related laws and regulations may also be applied to implementations of the present disclosure.

The term “responsive to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

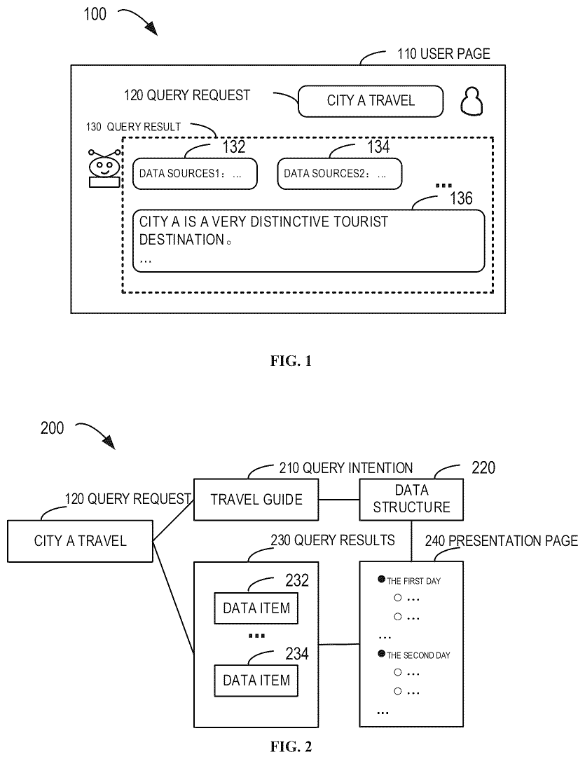

The application may provide a query service to the user. The application may obtain a query request (for example, a query text input by the user, that is, a “question”) from the user, and provide a query result corresponding to the question based on the query request. FIG. 1 is a block diagram 100 of an application environment according to some implementations of the present disclosure. As shown in FIG. 1, a query request 120 from a user may be received in the user page 110, and the user may input “city A travel”, for example.

The user page 110 may provide query results 130 obtained in different ways. For example, a search may be performed based on the query request 120 to find a plurality of data sources 132, 134 (e.g., web pages, etc.) that describe travel of the city A, and the like. For another example, the user page 110 may provide a generative result, for example, a capability of the machine learning model may be invoked to generate the introduction 136 about the travel resource of the city A.

However, the query result provided by the existing application may not meet the user requirement, and the user may need to continuously adjust the query request and execute multiple queries. On the other hand, the query results may involve multi-modal data, which results in the user having to manually neaten the query results in order to obtain an expected answer. At this point, it may be desirable to determine and present the query results in a more efficient manner.

### Summary of Presenting Query Results

In order to at least partially solve the deficiencies in the prior art, according to an exemplary implementation of the present disclosure, a method for presenting a query result is provided. A summary of one exemplary implementation according to the present disclosure is described with reference to FIG. 2, which shows a block diagram 200 for presenting a query result according to some implementations of the present disclosure.

As shown in FIG. 2, a query request 120 from a user may be received and a query intention 210 of the user is determined. In turn, based on the query intention 220, a data structure 220 may be determined for presenting the query results 239 for the query request 120. Here, the data structure 220 may describe a layout format for presenting the query results, thereby presenting the query results to the user in a more understandable manner. A set of data items (e.g., data items 232, . . . , and 234) in the query results 230 can be obtained based on the query request 120 and the data structure 220, thereby presenting a set of data items 232, . . . , and 234 based on data structure 220.

For example, for a query request “city A travel,” it may be determined that the query intent 210 is to obtain a travel guide. At this point, the data structure 220 may specify that the query result is presented in chronological order, and specifically, the specific itinerary of the day may be described in terms of “day” as a time unit. At this point, the presentation page 240 generated according to the data structure 220 may include the itinerary of the first day, the itinerary of the second day, etc. Alternatively and/or additionally, the data structure 220 may specify that the query results are presented in other ways, such as presenting a travel guide in terms of spatial locations in the city A, etc.

According to the exemplary implementation of the present disclosure, the presentation manner of the query result may be customized according to the user intention, and the query result is displayed in the rich media structured data, so that the query result is presented in a manner more easily understood by the user.

### Detailed Procedure for Presenting Query Results

Having described a summary according to some implementations of the present disclosure, more details regarding presenting query results will be described below. According to some implementations of the present disclosure, a pre-generated machine learning model may be used to determine a query intention of a user. The machine learning model may be trained based on history data with truth labels and may reflect an association relationship between query requests and query intentions. In particular, there may be a plurality of predetermined query intentions, for example, including but not limited to: searching for travel guide, searching for news events, searching for multimedia resources, items recommendations, and the like.

According to some implementations of the present disclosure, the intention recognition model may be constructed, and the user query is refined in terms of multiple vertical categories related to the user query, thereby determining the query intention of the user. For example, for a travel guide, refinement may be performed in one or more of the following aspects: number of people, gender, type (couple, parent, home-play), thereby identifying refined intention.

According to some implementations of the present disclosure, it may be determined that the query request specifies a user's concern factor. Here, a concern factor may represent a factor that the user is particularly concerned about during the query. At this point, the query intention may be determined based on the concern factor. For example, the query request may include: “I want to travel three days in city A.” At this point, it can be determined that “three days” is a factor of particular concern to the user, so the determined query intention can be further refined as: searching for a travel guide and a time length for three days. For another example, the query request may include: “I want to go to several large cities in Country B”. At this point, it can be determined that the “large city” is a factor of particular concern to the user, and thus the determined query intention can be further refined as: searching for a travel guide and a large city. In this way, the user requirement may be refined, and the query result may be presented in a more manner that is more in line with user requirement.

According to some implementations of the present disclosure, it is assumed that the query request has too little content and the query intention of the user cannot be accurately determined, and the user may be further suggested to refine the requirement. In particular, in response to determining that the query request does not specify a concern factor for the user, a message may be sent to the user to suggest the user to refine the query request. Assuming that the query request includes only “city A”, the user may be asked which aspects of City A are more concerned about, such as: what aspects of City A do you want to know about, 1) attractions; 2) traffic; 3) accommodations; and so on. Specifically, a more refined query request may be obtained gradually through one or more rounds of questioning and answering, thereby providing accuracy of the query.

According to some implementations of the present disclosure, a corresponding data structure may be set for each predetermined query intention. For example, for searching for a travel guide, the data structure may be organized in a plurality of time periods (e.g., days), that is, the data structure may include a plurality of nodes divided according to a time period. For another example, for searching for news events, the data structure may be organized according to a development sequence of the event at each time point, that is, the data structure may include a plurality of nodes divided according to a time point. For another example, for item recommendation, the data structure may be organized in a comparison manner, that is, the data structure may include a plurality of nodes divided according to respective parameters of the item.

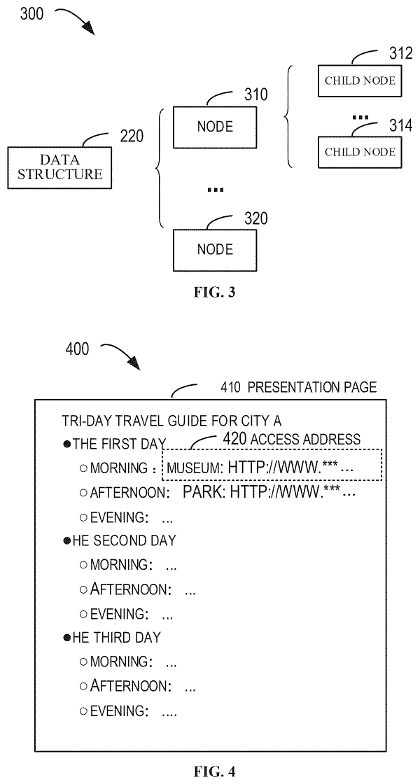

Further details are described with reference to FIG. 3, which illustrates a block diagram 300 of a data structure for presenting query results in accordance with some implementations of the present disclosure. As shown in FIG. 3, the data structure 220 may include a set of nodes (e.g., nodes 310, . . . , and 320). Further, in the process of determining the data structure based on the query intent, a set of nodes may be specified based on the concern factors. Specifically, in response to determining that the concern factor is the temporal type, a set of nodes is specified in a temporal manner. At this point, a node in the set of nodes specifies the type of data presented in the node. For example, for searching for a travel guide, each node may be divided according to a time period. In this way, the nodes may be specified based on the most concern factors of the user, so that the user can directly determine relevant search results of each time period.

Continuing with the example above, assuming that the user desires to search for a tri-day travel guide for city A, in this case, node 310 may specify that the relevant travel destination on the first day is presented in that node, . . . , node 320 may specify that the relevant travel destination on the third day is presented in that node. In this way, it is not necessary for the user to manually select from a large amount of travel data and determine a daily itinerary, but rather may directly present the three-day itinerary information for city A to the user in a structured way.

Alternatively and/or additionally, the node may further include a more fine grained child node, e.g., node 310 may include child nodes 312, . . . , 314. Here, each child node may specify the type of data presented in that node. For example, child node 312 may specify that a first day morning related activity is presented in the node, . . . , child node 314 may specify that a first day evening related activity is presented in the node, and so on. According to example implementations of the present disclosure, the hierarchy may be divided according to different granularities in a structured manner, so as to present a query result in a manner more consistent with a user expectation.

According to some implementations of the present disclosure, to obtain a set of data items in a query result, for a node in a set of nodes, a data item in the set of data items may be determined based on the query request and a type of data specified by the node. In other words, data related to each node may be obtained. Specifically, data about each scenic spot in city A may be obtained, and a daily travel plan is formulated according to a distance between each scenic spot, that is, a data item corresponding to each node is determined. Alternatively and/or additionally, further queries may be performed based on specific data types in the data items, thereby determining data items corresponding to each node. For example, a prompt word may be constructed: “city A travel, where to go on the first day”, etc., in order to obtain richer query results.

Referring to FIG. 4, more details on presenting a query result are described, and FIG. 4 shows a block diagram 400 of a presentation page of a query result according to some implementations of the present disclosure. As shown in FIG. 4, the activity content per day may be determined in the manner described above, for example, the user may be suggested to visit the museum in the morning of the first day, visit the park in afternoon, and so on. According to some implementations of the present disclosure, a service entry for accessing a data item may be provided for a data item in a set of data items. For example, for a museum, a service entry may include an access address 420 for a user to purchase tickets via the access address 420, and so on. Alternatively and/or additionally, more service entries meeting user intention may be provided, including, but not limited to: ticket services, traffic services, hotel reservation services, restaurant reservation services, and the like.

According to some implementations of the present disclosure, in a process of presenting a set of data items based on a data structure, a layout style of a set of data items may be set based on a set of nodes, and a set of data items is presented based on the layout style. Specifically, a layout style of a node of each hierarchy may be specified, for example, a specific indentation manner, a font size, a font color, a background color, and the like may be specified. With example implementations of the present disclosure, a more prominent visual effect may be presented, facilitating the user to find desired data.

It should be understood that although the query result is shown in text format only, the query result may include multiple modalities of data items, for example, including but not limited to text, images, audio, video, and the like. In this way, rich media information can be presented in a structured manner, providing richer query results.

According to some implementations of the present disclosure, the user may adjust various data items in the query result. Specifically, in response to receiving the adjustment request of the user for the data item in the query result, the adjusted set of data items may be presented. For example, the user may exchange the morning and afternoon itineraries on the first day, at this point the location of the relevant information for “museum” and “park” in the presentation page 410 may be exchanged. With example implementations of the present disclosure, it is convenient for users to customize their own schedule plan based on the query results. In this way, user operation complexity can be reduced, thereby improving efficiency.

According to some implementations of the present disclosure, the presentation page 410 may further include a page element for confirming the itineraries. In response to receiving the user request for the page element, itinerary information generated via the query result may be confirmed. Specifically, in the case that the user specifies a specific date, each service entry in the presentation page may be automatically accessed, and the ticket for the corresponding date is purchased, and so on. For example, assuming that the user specifies that the start date of the travel as January 1st, then in the case that the user's confirmation is received, the museum ticket for the morning on January 1st may be automatically reserved, and the like. Alternatively and/or additionally, confirmed itinerary information may be added to the user's calendar application to alert the user.

It should be understood that the foregoing is merely an example in which a data structure is determined in a temporal manner as an example for describing a presentation page. Alternatively and/or additionally, the data structure may be determined in other ways. Specifically, in response to determining that the concern factor is a spatial type, a set of nodes may be specified in a spatial manner. Assume that the query request includes: “I want to go to several large cities in Country B”. In this case, it may be determined that the user is more concerned about the spatial distribution of several large cities in the country B, and at this time, a set of nodes may be specified in a spatial manner. For example, a set of nodes may correspond to a city C1, a city C2, a city C3, and the like, and each related child node of the city C1 may respectively correspond to relevant information of hotels, attractions, and traffic in the city. In this case, corresponding prompt words and/or search keywords may be constructed to determine relevant tourism information of the city C1, the city C2, and the city C3, respectively.

FIG. 5 shows a block diagram 500 of a presentation page of a query result according to some implementations of the present disclosure. As shown in FIG. 5, relevant tourism information of the city C1, the city C2, and the city C3 may be respectively presented in various levels according to the spatial distribution. Relevant information about hotels, attractions, and traffic in various cities may be further presented in the refinement hierarchy. In this way, the user can conveniently know more travel information of each city in a spatial distribution manner, thereby avoiding the user from repeatedly modifying the query request to search for more information.

With example implementations of the present disclosure, the rich media data structure for presenting the answer result to the user may be determined according to the user intention. A dedicated rich media data structure is designed based on user intention, and the user problem is comprehensively answered. In this case, the travel itinerary may be displayed in a temporal manner and/or a spatial manner, for example, including a map, a text introduction, and the like. The user can obtain richer query results without further querying.

It should be understood that although only the case in which the data structure includes two levels (nodes and sub-nodes) is shown above, the data structure may include more or fewer levels. Users can access nodes in various levels in order to constantly obtain richer information.

According to some implementations of the present disclosure, to improve the speed of returning the query result, the specific content of the data item to be presented at each level may be gradually obtained in a hierarchical order. For example, the presentation page 510 may be returned at an initial stage. More information about the hotel may be further obtained in response to receiving the user interaction with the data item 520. For example, the hotel's address, price, access address, etc. may be presented. In this way, a corresponding query result may be obtained according to a continuously refined query request. Further, real-time data in the query result may be determined, for example, for data such as a hotel price, a refresh operation may be performed at a predetermined time interval, thereby providing latest data to the user.

Examples of presenting query results have been described above in terms of determining travel guide, alternatively and/or additionally, the query request may relate to other query intentions and the user's concern factor may also vary. According to some implementations of the present disclosure, in response to determining that the concern factor is a contrastive type, a set of nodes is specified in a comparison manner. For example, the query request may include: “I want to buy a new mobile phone”. At this time, the intention may be refined by using the machine learning model, for example, the user's requirements on storage capacity, screen size, operating system, usage, etc. may be determined. In a case where it is recognized that the intention is a visual intention such as mainly photographing, movie watching, etc., and the parameter comparison of each model of mobile phone is concerned, a set of nodes in the data structure may be determined in a comparison manner.

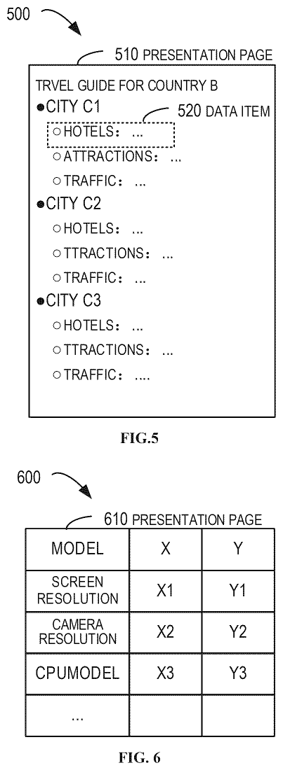

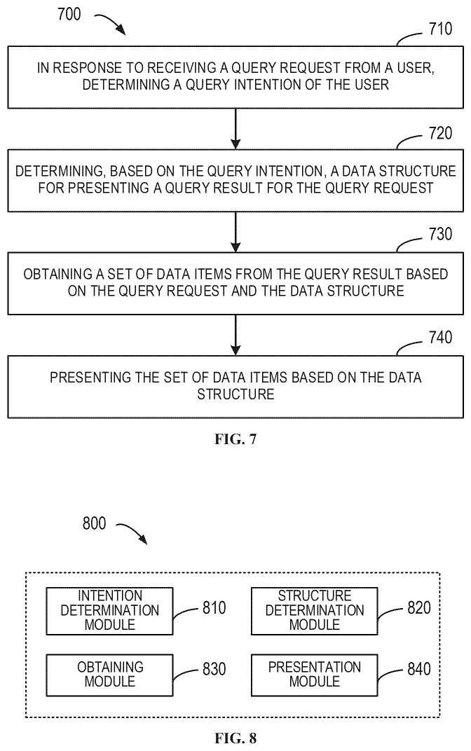

FIG. 6 shows a block diagram 600 of a presentation page of a query result according to some implementations of the present disclosure. As shown in FIG. 6, the presentation page 610 may adopt the form of a comparison table. In this case, the first row corresponds to the model number of the two candidate mobile phones to be recommended, and the subsequent rows respectively show corresponding parameter comparisons, for example, screen resolution, camera resolution, CPU model, and the like. In this way, the user can quickly know the performance comparison of multiple aspects of the two candidate mobile phones through the comparison table, thereby facilitating the user to select the product meeting its own needs.

According to some implementations of the present disclosure, different concern factors may result in different parameter comparison lists. For example, a user may pay more attention to the photographing parameter of the mobile phone, at this time, various parameters related to the camera may be arranged in front of the list, and other parameters may be arranged in the back position. For another example, if another user desires to run a large game on a mobile phone, a computing performance parameter of the mobile phone is more concerned, at this time, various parameters related to the computing unit may be arranged in front of the list, and other parameters may be arranged in the back position. In this way, in the query result, the corresponding data structure may be used to highlight the parameter that the user is more concerned, thereby satisfying the query requirement of the user in a more accurate manner.

Alternatively and/or additionally, the presentation page 610 may further include a service entry for obtaining more information about various data items. For example, a shopping address for purchasing each candidate cell phone may be provided, and a query address for querying detailed information about various parameters may be provided, and the like.

According to the exemplary implementation of the present disclosure, the presentation manner of the query result may be customized according to the user intention, and the query result is displayed in the rich media structured data, thereby presenting the query results in a manner more easily understood by the user, and avoiding further manual queries by the user.

### Example Processes

FIG. 7 shows a flowchart of a method 700 for presenting a query result according to some implementations of the present disclosure. At block 710, in response to receiving a query request from the user, determining a query intention of the user; at block 720, determining, based on the query intention, a data structure for presenting a query result for the query request; at block 730, obtaining a set of data items from the query result based on the query request and the data structure; and at block 740, presenting the set of data items based on the data structure.

According to some implementations of the present disclosure, determining the query intention of the user includes: in response to determining that the query request specifies the concern factor of the user, determining the query intention based on the concern factor.

According to some implementations of the present disclosure, determining the query intention of the user includes: in response to determining that the query request does not specify a concern factor of the user, sending a message to the user to suggest the user to refine the query request.

According to some implementations of the present disclosure, the data structure includes a set of nodes, a node in the set of nodes specifying a type of data presented in the node, and determining the data structure based on the query intention includes specifying a set of nodes based on the concern factor.

According to some implementations of the present disclosure, obtaining the set of data items from a query result includes: determining, for a node in the set of nodes, a data item in the set of data items, based on the query request and a type of data specified by the node.

According to some implementations of the present disclosure, specifying the set of nodes based on the concern factor includes in response to determining that the concern factor is of a temporal type, specifying the set of nodes in a temporal manner.

According to some implementations of the present disclosure, specifying the set of nodes based on the concern factor includes: in response to determining that the concern factor is a spatial type, specifying the set of nodes in a spatial manner.

According to some implementations of the present disclosure, specifying the set of nodes based on a concern factor includes: in response to determining that the concern factor is a contrastive type, specifying the set of nodes in a contrastive manner.

According to some implementations of the present disclosure, presenting the set of data items based on the data structure includes: setting a layout style of the set of data items based on the set of nodes; and presenting the set of data items based on the layout style.

According to some implementations of the present disclosure, the method further includes: providing, for a data item in the set of data items, a service entry for accessing the data item.

### Example Apparatus and Device

FIG. 8 shows a block diagram of an apparatus 800 for presenting a query result according to some implementations of the present disclosure. The apparatus includes: an intention determination module 810 configured to determine a query intention of a user in response to receiving a query request from the user; a structure determination module 820 configured to determine, based on the query intention, a data structure for presenting a query result for the query request; an obtaining module 830 configured to obtain a set of data items from the query result based on the query request and the data structure; and a presentation module 840 configured to present the set of data items based on the data structure.

According to some implementations of the present disclosure, the intention determination module 810 is further configured to: determine a query intent based on the attention factor, in response to determining that the query request specifies the concern factor of the user.

According to some implementations of the present disclosure, the intention determination module 810 is further configured to: send a message to the user to suggest the user to refine the query request, in response to determining that the query request does not specify a concern factor of the user.

According to some implementations of the present disclosure, the data structure includes a set of nodes, a node of the set of nodes specifies a type of data presented in the node, and the structure determination module 820 is further configured to specify a set of nodes based on the concern factor.

According to some implementations of the present disclosure, the obtaining module 830 is further configured to: determine, for a node in the set of nodes, a data item in the set of data items based on the query request and a type of data specified by the node.

According to some implementations of the present disclosure, the structure determining module 820 is further configured to: specify the set of nodes in a temporal manner, in response to determining that the attention factor is a temporal type.

According to some implementations of the present disclosure, the structure determining module 820 is further configured to: specify the set of nodes in a spatial manner, in response to determining that the concern factor is a spatial type.

According to some implementations of the present disclosure, the structure determining module 820 is further configured to: specify the set of nodes in a contrastive manner, in response to determining that the concern factor is a contrastive type.

According to some implementations of the present disclosure, the presentation module 840 is further configured to: set a layout style of the set of data items based on a set of nodes; and present the set of data items based on the layout style.

According to some implementations of the present disclosure, the presentation module 840 is further configured to provide, for a data item in the set of data items, a service entry for accessing the data item.

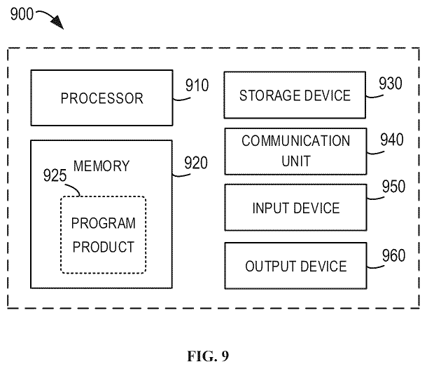

FIG. 9 illustrates a block diagram of a device 900 capable of implementing various implementations of the present disclosure. It should be understood that the computing device 900 shown in FIG. 9 is merely exemplary and should not constitute any limitation on the functionality and scope of the implementations described herein. The computing device 900 shown in FIG. 9 may be configured to implement the method described above.

As shown in FIG. 9, the computing device 900 is in the form of a general-purpose computing device. Components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor systems, multiple processing units execute computer-executable instructions in parallel to improve parallel processing capabilities of computing device 900.

Computing device 900 typically includes a plurality of computer storage media. Such media may be any available media accessible by the computing device 900, including, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 930 may be a removable or non-removable medium and may include a machine-readable medium, such as a flash drive, magnetic disk, or any other medium, which may be capable of storing information and/or data (e.g., training data for training) and may be accessed within computing device 900.

The computing device 900 may further include additional removable/non-removable, volatile/non-volatile storage media. Although not shown in FIG. 9, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 920 may include a computer program product 925 having one or more program modules configured to perform various methods or actions of various implementations of the present disclosure.

The communications unit 940 implements communications with other computing devices over a communications medium. Additionally, the functionality of components of the computing device 900 may be implemented in a single computing cluster or multiple computing machines capable of communicating over a communication connection. Thus, the computing device 900 may operate in a networked environment using logical connections with one or more other servers, network personal computers (PCs), or another network node.

The input device 950 may be one or more input devices, such as a mouse, a keyboard, a trackball, or the like. The output device 960 may be one or more output devices, such as a display, a speaker, a printer, or the like. Computing device 900 may also communicate with one or more external devices (not shown) as needed, such as storage devices, display devices, etc., communicate with one or more devices that enable a user to interact with computing device 900, or communicate with any device (e.g., network card, modem, etc.) that enables computing device 900 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above. According to example implementations of the present disclosure, there is provided a computer program product having stored thereon a computer program, which when executed by a processor, implements the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for presenting a query result, comprising:
in response to receiving a query request from a user, determining a query intention of the user;
determining, based on the query intention, a data structure for presenting a query result for the query request;
obtaining a set of data items from the query result based on the query request and the data structure; and
presenting the set of data items based on the data structure.

2. The method of claim 1, wherein determining the query intention of the user comprises: in response to determining that the query request specifies a concern factor of the user, determining the query intention based on the concern factor.

3. The method of claim 1, wherein determining the query intention of the user comprises: in response to determining that the query request does not specify a concern factor of the user, sending a message to the user to suggest the user to refine the query request.

4. The method of claim 2, wherein the data structure comprises a set of nodes, a node in the set of nodes specifying a type of data presented in the node, and determining the data structure based on the query intention comprises specifying the set of nodes based on the concern factor.

5. The method of claim 4, wherein obtaining the set of data items from the query result comprises: determining, for the node in the set of nodes, a data item of the set of data items, based on the query request and a type of data specified by the node.

6. The method of claim 4, wherein specifying the set of nodes based on the concern factor comprises: in response to determining that the concern factor is of a temporal type, specifying the set of nodes in a temporal manner.

7. The method of claim 4, wherein specifying the set of nodes based on the concern factor comprises: in response to determining that the concern factor is of a spatial type, specifying the set of nodes in a spatial manner.

8. The method of claim 1, wherein specifying the set of nodes based on the concern factor comprises: in response to determining that the concern factor is of a contrastive type, specifying the set of nodes in a contrastive manner.

9. The method of claim 1, wherein presenting the set of data items based on the data structure comprises:
setting a layout style of the set of data items based on the set of nodes; and
presenting the set of data items based on the layout style.

10. The method of claim 1, further comprising: providing, for a data item in the set of data items, a service entry for accessing the data item.

11. (canceled)

12. An electronic device, comprising:
at least one processor; and
at least one memory coupled to the at least one processor and storing instructions for execution by the at least one processor, the instructions, when executed by the at least one processor, causing the electronic device to perform acts comprising:
in response to receiving a query request from a user, determining a query intention of the user;
determining, based on the query intention, a data structure for presenting a query result for the query request;
obtaining a set of data items from the query result based on the query request and the data structure; and
presenting the set of data items based on the data structure.

13-14. (canceled)

15. The device of claim 12, wherein determining the query intention of the user comprises: in response to determining that the query request specifies a concern factor of the user, determining the query intention based on the concern factor.

16. The device of claim 12, wherein determining the query intention of the user comprises: in response to determining that the query request does not specify a concern factor of the user, sending a message to the user to suggest the user to refine the query request.

17. The device of claim 15, wherein the data structure comprises a set of nodes, a node in the set of nodes specifying a type of data presented in the node, and determining the data structure based on the query intention comprises specifying the set of nodes based on the concern factor.

18. The device of claim 17, wherein obtaining the set of data items from the query result comprises: determining, for the node in the set of nodes, a data item of the set of data items, based on the query request and a type of data specified by the node.

19. The device of claim 17, wherein specifying the set of nodes based on the concern factor comprises: in response to determining that the concern factor is of a temporal type, specifying the set of nodes in a temporal manner.

20. The device of claim 17, wherein specifying the set of nodes based on the concern factor comprises: in response to determining that the concern factor is of a spatial type, specifying the set of nodes in a spatial manner.

21. The device of claim 12, wherein specifying the set of nodes based on the concern factor comprises: in response to determining that the concern factor is of a contrastive type, specifying the set of nodes in a contrastive manner.

22. The device of claim 12, wherein presenting the set of data items based on the data structure comprises:
setting a layout style of the set of data items based on the set of nodes; and
presenting the set of data items based on the layout style.

23. A non-transitory computer-readable storage medium having stored thereon a computer program which, when executed by a processor, causes the processor to implement a method comprising:
in response to receiving a query request from a user, determining a query intention of the user;
determining, based on the query intention, a data structure for presenting a query result for the query request;
obtaining a set of data items from the query result based on the query request and the data structure; and
presenting the set of data items based on the data structure.
